(19) United States
(12) Patent Application Publication
(10) Pub. No.: US 2026/0222797 A1
(43) Pub. Date: Jul. 30, 2026

(54) INDICATING PARTICIPATION IN LEARNING MODEL TRAINING

(71) Applicant: Lenovo (United States) Inc., Morrisville, NC (US)

(72) Inventors: Tapisha Soni, Munich (DE); Abdul Rasheed Mohammed, Hyderabad (IN); Vahid Pourahmadi, München (DE); Joachim Löhr, Wiesbaden (DE)

(73) Assignee: Lenovo (United States) Inc., Morrisville, NC (US)

(21) Appl. No.: 19/041,314

(22) Filed: Jan. 30, 2025

(51) Int. Cl. H04W 8/24; H04L 41/16

(52) U.S. Cl. CPC H04W 8/24; H04L 41/16

(57) ABSTRACT

Various aspects of the present disclosure relate to methods for artificial intelligence and machine learning model training. An apparatus, such as a UE, computes a readiness score for participation, by the UE, in tasks associated with learning model training, where the readiness score corresponds to one or more parameters associated with performance of the UE. The UE transmits, to a network equipment (NE), an indication of the readiness score. The tasks can include data collection, performing measurements, logging measured data, and reporting data, among other examples. The one or more parameters may include UE battery conditions, a hardware configuration, one or more buffer statuses, and statuses of existing tasks at the UE, among other examples. In response to the indication of the readiness score, the NE transmits a task configuration for the one or more tasks in accordance with the readiness score.

### TECHNICAL FIELD

The present disclosure relates to wireless communications, and more specifically to artificial intelligence (AI) and machine learning (ML) model training in wireless networks.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to compute a score indicative of a readiness of the UE, to participate in one or more tasks associated with learning model training, based on UE information, and transmit an indication of the score.

A processor for wireless communication is described. The processor may be configured to, capable of, or operable to perform one or more operations as described herein. For example, the processor may be configured to, capable of, or operable to compute a score indicative of a readiness of the processor, to participate in one or more tasks associated with learning model training, based on processor information, and transmit an indication of the score.

A method performed or performable by a UE for wireless communication is described. The method may include computing a score indicative of a readiness of the UE, to participate in one or more tasks associated with learning model training, based on UE information, and transmitting an indication of the score.

In some implementations of the UE, the processor, and the method described herein, the UE may receive a configuration, where the configuration includes at least one of a quantization scheme, a quantity of bits, a periodicity, one or more trigger events, or a set of parameters for which the score is to be computed, where the indication of the score is transmitted based on the configuration. In some implementations, the UE may receive a configuration for the one or more tasks, and perform the one or more tasks based on the score and the received configuration. In some implementations, the UE may participate in the learning model training based on a value of the score satisfying a threshold, or refrain from participating in the learning model training based on the value of the score satisfying the threshold.

In some implementations of the UE, the processor, and the method described herein, to compute the score, the UE may compute a respective score for each functionality of a set of functionalities associated with learning model life cycle management (LCM). In some implementations, the indication may include a bitmap, where each functionality of the set of functionalities corresponds to a respective bit value that is indicative of the readiness of the UE to support the respective functionality.

In some implementations of the UE, the processor, and the method described herein, the UE information may include a set of parameters, and where, to compute the score, the UE may compute a respective score for each parameter of the set of parameters. In some implementations, the indication may include a bitmap, where each parameter of the set of parameters corresponds to a respective bit value that is indicative of the readiness of the UE according to the respective parameter. In some implementations, to compute the score, the UE may compute an average score based on the respective score for each parameter of the set of parameters, where the indication represents the computed average score.

In some implementations of the UE, the processor, and the method described herein, the UE may transmit the indication of the score based on a trigger event, where the trigger event includes one or more of a change in a value of the score, a determination that the score satisfies a threshold, or a request to perform the learning model training or report the score.

In some implementations of the UE, the processor, and the method described herein, the one or more tasks may include collecting data, performing measurements, logging data, or reporting data. In some implementations, the UE information may include a set of parameters including one or more of a battery status of the UE, a hardware configuration of the UE, a buffer status of the UE, or a status of a current task performed by the UE. In some implementations, to transmit the indication of the score, the UE may transmit the indication via UE capability information, radio resource control (RRC) signaling, or a medium access control (MAC) control element (MAC-CE).

An NE for wireless communication is described. The NE may be configured to, capable of, or operable to perform one or more operations as described herein. For example, the NE may be configured to, capable of, or operable to receive, from a UE, an indication of a score indicative of a readiness of the UE, to participate in one or more tasks associated with learning model training, based on UE information, and transmit a configuration for the one or more tasks based on the score.

A processor for wireless communication is described. The processor may be configured to, capable of, or operable to perform one or more operations as described herein. For example, the processor may be configured to, capable of, or operable to receive, from a UE, an indication of a score indicative of a readiness of the UE, to participate in one or more tasks associated with learning model training, based on UE information, and transmit a configuration for the one or more tasks based on the score.

A method performed or performable by an NE for wireless communication is described. The method may include receiving, from a UE, an indication of a score indicative of a readiness of the UE, to participate in one or more tasks associated with learning model training, based on UE information, and transmitting a configuration for the one or more tasks based on the score.

In some implementations of the NE, the processor, and the method described herein, the indication may include a bitmap, the UE information may include a set of parameters, each parameter of the set of parameters may correspond to a respective bit value that is indicative of the readiness of the UE according to the respective parameter, and the NE may compute an average score for the UE based on the indication. In some implementations, the NE may transmit signaling instructing the UE to perform the one or more tasks based on the average score.

In some implementations of the NE, the processor, and the method described herein, the indication may include a bitmap, the UE information may include a set of functionalities associated with learning model LCM, each functionality of the set of functionalities may correspond to a respective bit value that is indicative of the readiness of the UE to support the respective functionality, and the NE may compute an average score for the UE based on the indication. In some implementations, the NE may transmit signaling instructing the UE to perform the one or more tasks based on the average score.

In some implementations of the NE, the processor, and the method described herein, the one or more tasks may include collecting data, performing measurements, logging data, or reporting data. In some implementations, the UE information may include a set of parameters including at least one of a battery status of the UE, a hardware configuration of the UE, a buffer status of the UE, or a status of an existing task being performed by the UE. In some implementations, to receive the indication of the score, the NE may receive the indication via UE capability information, RRC signaling, or a MAC-CE.

In some implementations of the NE, the processor, and the method described herein, the NE may transmit signaling indicating a configuration, where the configuration includes at least one of a quantization scheme, a quantity of bits, a periodicity, one or more trigger events, or a set of parameters for which the score is to be computed, where the indication of the score is received in accordance with the configuration. In some implementations, the NE may transmit a task reconfiguration for the one or more tasks based on the score.

### BRIEF DESCRIPTION OF THE DRAWINGS

Non-limiting and non-exhaustive examples are described with reference to the following figures.

FIG. 1 illustrates an example of a wireless communications system in accordance with aspects of the present disclosure.

FIG. 2 illustrates an example of a model functional framework, in accordance with aspects of the present disclosure.

FIGS. 3 and 4 illustrate examples of block diagrams for one-sided model structures, in accordance with aspects of the present disclosure.

FIG. 5 illustrates an example of a block diagram for a two-sided model structure, in accordance with aspects of the present disclosure.

FIG. 6 illustrates an example of a process flow, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

The following description sets forth example aspects of the present disclosure. It should be recognized, however, that such description is not intended as a limitation on the scope of the present disclosure. Rather, the description also encompasses combinations and modifications to those example aspects described herein.

In a wireless communications system, a UE and an NE (e.g., a base station, gNB) may support artificial intelligence (AI) and machine learning (ML) (AI/ML, hereinafter referred to as “AI”) to reduce overhead, improve performance, and reduce latency. AI can be implemented in a wide range of scenarios and for a variety of purposes, such as for channel state information (CSI) feedback compression and enhancement, beam management, modulation and demodulation, scheduling, interference management, positioning, and so forth. AI can leverage AI/ML models (referred to herein as “models” or “learning models”) which represent programs and/or algorithms trained on a set of data to provide outputs, such as to recognize patterns, make decisions, generate content, etc. Such models, for instance, can apply different algorithms to data inputs to obtain output used for performing different tasks.

AI in wireless communications systems involves life cycle management (LCM) processes and functions such as model training, model testing, and model inference. Models implemented for a given use case may be tailored toward, applicable to, and trained for particular datasets, scenarios, configurations, locations, and deployments, among other factors. Thus, models may undergo updates (e.g., model changes) as part of their development and as they are trained. In some examples, multiple nodes (e.g., UEs and NEs) of the wireless communications system may be involved in AI functionality, and each node may perform one or more LCM tasks. Data and output may be communicated between nodes. For example, multiple nodes may collect data for training a model. The nodes may communicate the collected data to an NE, which may perform the training. As another example, a model for an AI functionality supported by a first node (e.g., a UE) may be trained with a dataset subject to specific conditions of the first node and specific conditions of a second node (e.g., an NE) with which the first node communicates. Thus, for networks with multiple nodes that support the AI functionality, training the model(s) can result in multiple instances of the model(s).

An ideal model would be generalized for a particular functionality, capable of producing accurate and reasonable outputs given different datasets subject to different scenarios, configurations, and conditions of multiple nodes, and applicable to any other node. Given the substantial quantity of variable factors involved in a wireless communications system and in different datasets, however, creation of such an ideal model presents significant challenges. Different datasets often have unique characteristics, such as format, quality, and feature relevance, and often contain missing values or noise. Additionally, each node may be associated with different capabilities and constraints that impact the node's ability to implement the model. Moreover, the scenarios, configurations, and conditions may be subject to change over time and may be impacted by additional conditions, such as network conditions, user behavior, and the like. Thus, creating a single model capable of addressing so many variations without degradation in performance remains exceedingly difficult.

Design and optimization of AI procedures and models is therefore highly use-case dependent. However, many AI LCM functions, such as training, updating, fine-tuning, and monitoring models, depend on data collected from the environment. As such, a common framework for AI LCM data collection may be achieved. It should be noted that particular contents of collected data remains use-case dependent and should be studied separately for different applications.

Minimization of Drive Tests (MDT) is a feature introduced by the 3rd Generation Partnership Project (3GPP) for data collection from the environment. The aim of this feature is to enhance the performance of networks and improve user experience by optimizing network measurement and data collection processes. The goal is to reduce the reliance on drive tests, which are conventionally used to collect data for network optimization and troubleshooting. Drive tests involve sending personnel to physically drive around in vehicles equipped with measurement equipment to gather network performance data, which can be costly and time-consuming. In the MDT framework, instead of a designated test equipment, a UE can be configured to measure various network metrics and performance indicators such as signal strength (e.g., Reference Signal Received Power (RSRP)), quality (e.g., Reference Signal Received Quality (RSRQ)), and coverage. MDT is designed to collect data both in real-time and over long periods, with measurements being triggered by specific network events or collected periodically during regular device (e.g., UE) usage. Additionally, the UE may report the data immediately or based on a trigger event (e.g., when one or more predefined conditions are met), or may log the data for transmission at a later time (e.g., to avoid impacting user experience). This data can then be used by network operators to assess and improve network performance. Using different modes of data collection according to MDT enables operators to gather a comprehensive understanding of network conditions without deploying extensive field-testing resources. Further, such flexibility in data collection ensures continuous monitoring of network performance, allowing operators to quickly identify and resolve issues, optimize resource allocation, and enhance overall service quality. MDT leverages the widespread availability of UEs to provide a cost-effective and efficient way to maintain and improve mobile network performance.

MDT provides a useful blueprint for developing a common data collection associated with AI LCM functions. For example, in a wireless communications system, models may be trained according to respective configurations and types of the nodes at which they are implemented. To this end, multiple, diverse nodes participate in the training to ensure collection of sufficiently diverse datasets. As such, multiple UEs can be configured (e.g., by an NE) to perform measurements, collect data, and transmit collected data to a training node (e.g., the NE). In some cases, however, the NE may be unaware of UE conditions that can negatively impact performance when the UE performs data collection, such as when the UE has a relatively low battery. Mandatory training participation can therefore be detrimental to the UE and to user experience.

Accordingly, the techniques described herein enable a UE to indicate a preference for and consent (e.g., acknowledge, opt-in) to participate in model training tasks, such as data collection. This indication can be based on one or more factors (e.g., parameters, metrics, criteria) that define a UE's readiness to participate in the model training tasks, such as a battery status, a hardware configuration, a buffer status, or a status of one or more ongoing (e.g., current, pending, existing) tasks being performed by the UE. For example, the UE may compute (e.g., determine, obtain, select, identify, calculate) a score (also referred to as a readiness score) that corresponds to the one or more factors and indicates whether the UE is capable of and/or prepared to participate in the model training tasks. The UE may participate in the model training tasks if the readiness score satisfies a threshold (e.g., is less than or equal to, greater than or equal to), and may refrain (e.g., opt-out) from participation if the readiness score satisfies the threshold (e.g., fails to satisfy the threshold). The UE may transmit (e.g., report) an indication of the readiness score to an NE, or other device (e.g., a relay UE), for example, periodically or based on a trigger event, via UE capability information, RRC signaling, or a MAC-CE.

The indication may include actual values of the readiness score(s) or may include a bitmap corresponding to the readiness score(s). In some examples, the UE computes the readiness score on a per-factor or a per-functionality basis. In such examples, the UE may indicate a respective readiness score for each factor or functionality. Additionally, or alternatively, the UE may compute an average score based on the respective readiness scores and may transmit an indication of the average score. In some cases, the NE may transmit, to the UE, a report configuration according to which the UE transmits the indication. The report configuration may indicate a quantization scheme, a quantity of bits, a periodicity, one or more trigger events, and/or one or more parameters for which the readiness score is to be computed. Based on the received indication, the NE may determine whether the UE is to participate in the model training tasks. For example, if the UE indicates respective readiness scores, the NE may compute an average readiness score and compare the average readiness score to the threshold. If the NE determines that the UE is to participate, the NE may transmit signaling instructing the UE to perform the model training tasks, a task configuration for the model training tasks, or a combination thereof.

The techniques described herein enable a UE to provide an NE with relevant information that the NE may otherwise be unable to obtain, such as updated information. For example, model training tasks can be computationally demanding and consume significant resources. The NE may be unaware that the UE has limited resources available, e.g., due to existing tasks being performed by the UE. In such cases, mandatory training participation would force the UE to divert processing power to model training tasks, resulting in performance degradation and negatively impacting a user's experience. Thus, the described techniques enable the NE to consider the UE's preferences and conditions when assigning and configuring AI-related tasks. By communicating readiness scores to the NE, the UE can participate in model training tasks only when the UE is prepared and capable of doing so, thereby avoiding degradation of UE performance and user experience. Additionally, by utilizing the described techniques, consistent utilization of AI models and/or functionality across a wireless communication network (e.g., at UEs and/or NEs) can be realized, which can increase signaling accuracy, reduce signaling errors, and reduce signaling overhead.

Aspects of the present disclosure are described in the context of a wireless communications system.

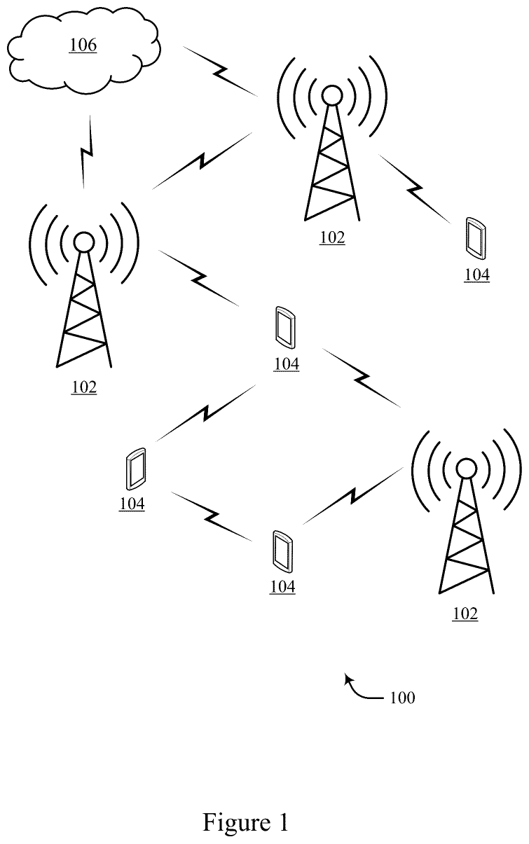

FIG. 1 illustrates an example of a wireless communications system 100 in accordance with aspects of the present disclosure. The wireless communications system 100 may include one or more NEs 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=³, μ=⁴) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the wireless communications system 100 can include one or more transmitting devices that transmit signaling, including data and/or control signaling, to one or more devices that receive the signaling (e.g., receiving devices). Example transmitting devices include, but are not limited to, NEs 102 and/or UEs 104. Additionally, or alternatively, example receiving devices include, but are not limited to, NEs 102 and/or UEs 104. The transmitting devices and the receiving devices can communicate via one or more channels (e.g., wireless channels). A channel includes a medium through which signaling propagate between the transmitting devices and the receiving devices. In some variations, the transmitting devices and/or the receiving devices can have multiple antennas. For example, a UE 104 can have r antennas and an NE 102 (e.g., base station or gNB) can have t antennas. A channel between the NE 102 and the UE 104 has a total of rt number of paths. A path defines a route or trajectory that an electromagnetic wave takes from a transmitting device to a receiving device. A signal can follow one or more paths from a transmitting device to a receiving device due to propagation, such as reflection, diffraction, and scattering.

In downlink communication, in which an NE 102 transmits signaling to a UE 104, a discrete-time channel can be represented as a r×t dimensional complex-valued matrix H, with element hᵢⱼ of H denoting the complex-valued channel gain between i^{th} receive antenna and j^{th} transmit antenna, 1≤i≤r, 1≤j≤t. A discrete-time channel refers to a channel in which transmitted signals and received signals are represented and processed in discrete time instants or intervals. That is, the wireless communications system 100 uses discrete-time samples of signals rather than continuous-time signals. The channel gains, or the channel matrix H, depends on the physical propagation medium. The wireless channel is a time-varying channel due to the dynamic nature of the physical propagation medium. Further, the channel gains depend on the frequency the devices use for the signaling. For example, with a multicarrier waveform, such as OFDM, the channel matrix can have different values for different sub-carriers (e.g., frequencies) at a same instant of time. That is, the wireless channel matrix H is stochastic, varying across time, frequency, and spatial dimensions.

In some examples, one or more devices in the wireless communications system 100 can adapt a transmission method for a current channel realization and/or preprocess signaling to be transmitted according to a current channel realization to increase signaling throughput over a communication link while improving reliability of the communication link. A transmitting device can use CSI to achieve an adaptive transmission or to implement preprocessing at the transmitting device. For example, a transmitting device can determine a channel matrix H over a frequency range of operation (e.g., at respective subcarriers for OFDM and/or multi-carrier waveforms) when characteristics of a channel change.

One or more devices in the wireless communications system 100 may support models (e.g., learning models), functionalities, and features/FGs that are based on or otherwise associated with AI/ML. A network node, such as an NE 102, may manage implementation and operation of one or more models, functionalities, and/or features/FGs at one or more UEs 104. For example, the NE 102 may transmit signaling instructing one or more UEs 104 to activate, deactivate, switch between, or fall back from a model or functionality, such as for a particular AI-enabled feature/FG. Additionally, or alternatively, the NE 102 may configure and instruct one or more UEs 104 to perform AI-related tasks, which may include LCM functions such as data collection. For instance, a UE 104 may perform measurements, collect data, and transfer the data to the NE 102. The NE 102 can transmit, to the UE 104, a configuration for performing the data collection, where the configuration can indicate measurements to be performed, data to be collected, and other parameters. In some cases, a UE 104 can make decisions regarding AI-related tasks, e.g., autonomously or by communicating requests to the NE 102.

The present disclosure pertains to models including one-sided models and two-sided models. In one-sided models, the model is located either at a node A or a node B, and data, model outputs, and other associated information may be communicated between the nodes. The node A and the node B may each be an example of an NE 102 or a UE 104. A model located at a node A is referred to herein as M_{A}, and a model located at a node B is referred to herein as M_{B}. In a two-sided model, a first portion of the model is located at a node A (e.g., an NE 102, a UE 104) and a second portion of the model is located at a node B (e.g., an NE 102, a UE 104). In such examples, the first portion of the model may be referred to as an encoding model Mₑ, while the second portion of the model may be referred to as a decoding model M_{d}.

An AI feature/FG (also referred to herein as “feature/FG”) may be defined as a capability, operation, behavior, procedure, task, etc. that leverages and/or is enabled by AI. As described herein, the term “AI functionality” (also referred to herein as “functionality”) refers to an AI feature at a granularity of a use-case or sub-use-case, applied for inference at a node (e.g., a UE 104, an NE 102). In some cases, the granularity of an AI functionality can be at a level of configuration for a particular use-case or sub-use-case. AI functionalities include, but are not limited to, beamforming, channel estimation, and positioning, among other examples.

A network node (e.g., a UE 104, an NE 102) may be capable of supporting a set of models, features/FGs, and functionalities. Additionally, different network nodes may be capable of supporting different models, features/FGs, and functionalities. Thus, to ensure efficient management and operation, a UE 104 may report AI capability-related information (e.g., UE capability information) to the network (e.g., to an NE 102), thereby enabling the network to make appropriate decisions related to activation, deactivation, switching, fallback, and the like. AI capability information can include indications of models, features/FGs, and/or functionalities supported by a UE 104. In some examples, a UE 104 reports AI capability information periodically and/or in response to a trigger event, such as reception of a request from the NE 102.

Additionally, a network node (e.g., a UE 104, an NE 102) may be capable of supporting one or more AI LCM functions, such as data collection, model training, inference, and the like. Model training can involve measuring, collecting, logging, and transferring (e.g., transmitting, reporting) data. As an example, an NE 102 may configure multiple UEs 104 to collect and transfer data to the NE 102, and the NE 102 can use the received data to train, re-train, and fine-tune a model. A model may have a higher likelihood of providing a high precision inference outcome if the model is trained with the same conditions, additional conditions, scenarios, and/or configuration that are observed at the time of inference. Thus, collecting data from multiple UEs 104 can improve accuracy and efficiency in model training and implementation. In terms of UE and network behavior, model training may be treated independently from other AI LCM functions, such as inference and monitoring. For example, a model can be trained and readily available at a UE 104 or it can be downloaded from a server, and then applied by the UE 104 for inference if applicable. As another example, performance monitoring of models is performed in close coordination with inference.

Given the possible variations in AI capabilities and related functions (e.g., AI LCM functions), an NE 102 may not assume that a particular UE 104 is able or prepared to participate in model training (e.g., tasks related to model training). As described herein, participation in model training refers to the process of data collection for which a UE is involved in measuring, collecting, and transferring (e.g., to a network node, such as an NE 102) data relevant to training one or more models. The data to be measured and collected for model training depends on the configuration provided by the network (e.g., a configuration transmitted to a UE 104 by an NE 102).

As such models are not UE-specific models, it may not be compulsory for all UEs 104 to contribute to a particular training (e.g., by collecting data). For instance, to train a model for specific UE-side conditions, a set of nodes (e.g., UEs 104) with matching conditions (e.g., hardware and/or configurations) can be used to perform training-related tasks, such that the model can be generalized for different UEs 104. As an example, UEs 104 from the same vendor or chip-set vendor may be likely to use one or more common models for a given feature/FG. Additionally, or alternatively, depending on a type of contract and/or service level agreement (SLA) with an operator, some UEs 104 may opt out of taking part in model training permanently or temporarily. Some UEs 104 may not want to participate in model training due to contractual terms and conditions.

Moreover, multiple factors can impact UE performance with respect to both model training and user experience as a result of performing model training. For example, a UE 104 may not be capable of performing data collection as configured by an NE 102 based on factors such as processing power, hardware configurations, battery levels, memory capabilities, energy consumption, and signaling overhead. Additionally, or alternatively, a UE 104 may be performing other tasks unrelated to training that consume resources (e.g., computational resources, communication resources, energy/battery power), such that performing model training may degrade performance for the other tasks and negatively impact user experience. These factors define a UE's readiness and ability to participate in model training.

Because such factors are UE-specific, the NE 102 may be unaware of and/or unable to determine (e.g., dynamically) whether a UE 104 is capable of and/or prepared to participate in model training. Additionally, due to potential impact of such factors on UE performance, mandatory participation of UEs 104 in model training can be detrimental to the UE 104 and to users. Thus, the techniques described herein support mechanisms to enable a UE 104 to consent to its participation in model training. For example, a UE 104 can compute a readiness score associated with participation, by the UE 104, in one or more tasks associated with one or more LCM functions (e.g., data collection, model training, inference, and the like, among other examples). The readiness score may be indicative of the UE's preparedness to perform the one or more tasks. A readiness score corresponding to a relatively low preparedness may indicate that the UE 104 is not prepared or not capable of performing the tasks. For example, the UE may have a relatively low battery, may be experiencing poor network conditions, or may not have sufficient computational power available (e.g., due to existing tasks or operations). A readiness score corresponding to a relatively high preparedness may indicate that the UE 104 is prepared and capable of performing the tasks.

The UE 104 computes the readiness score based on one or more parameters associated with performance of the UE 104, such as a battery status, a buffer status, a hardware configuration, or a task status of one or more existing tasks at the UE 104. A value of the readiness score indicates whether the UE 104 participates in (e.g., performs) the one or more tasks. For instance, the UE 104 may participate in the one or more tasks if the value satisfies a threshold, and may refrain from participation if the value fails to satisfy the threshold. The threshold can be either provided to the UE 104 by the NE 102 or the threshold can be applied dynamically (or up to implementation) by the NE 102.

In some examples, the UE 104 receives, from an NE 102, a configuration for reporting the readiness score, and the UE 104 transmits an indication of the readiness score to the NE 102 in accordance with the configuration. For instance, the configuration may indicate a quantization scheme and a quantity of bits to be used to indicate the readiness score. Additionally, or alternatively, the configuration can indicate one or more trigger events that trigger the UE 104 to transmit the indication, one or more parameters for which a readiness score is to be computed and reported, or the like, among other examples. In some cases, the UE 104 indicates a respective readiness score for each parameter of the one or more parameters and/or each functionality of a set of functionalities, and the NE 102 computes an average readiness score based on the respective readiness scores. Alternatively, the UE 104 can compute the average readiness score and transmit an indication of the average readiness score. In any case, based on the readiness score, the NE 102 can instruct (e.g., via signaling) the UE 104 to participate or to refrain from participating in the one or more tasks. Additionally, or alternatively, if the UE 104 is configured by the NE 102, the UE 104 may decide (e.g., autonomously) whether to participate in model training tasks, and may report an acknowledgment of the decision to the NE 102.

With reference to the utilization of AI in wireless communications systems, the following represent some examples of relevant features and/or terminology.

AI-enabled feature: A feature where AI may be used.

AI-enabled feature group (FG): A set of features where AI may be used.

AI functionality: An AI-enabled feature/FG enabled by configurations, where configurations can be supported based on conditions indicated by a UE.

AI model: A data-driven algorithm that applies AI techniques to generate a set of outputs based on a set of inputs.

AI model delivery: Delivery of a model from one entity to another entity in any manner. Examples of an entity include a network node and/or network function (e.g., NE, gNB, LMF, etc.), UE, proprietary server, etc.

AI model inference: A process of using a trained model to produce a set of outputs based on a set of inputs.

AI model testing: A subprocess of training to evaluate the performance of a final model using a dataset different from that used for model training and validation. In contrast to model validation, testing may not assume subsequent tuning of the model.

AI model training: A process to train a model (e.g., by learning an input/output relationship) in a data-driven manner and to obtain a trained model for inference.

AI model transfer: Delivery of a model over the air interface in a manner that is not transparent to 3GPP signaling. Such delivery may include, for example, parameters of a model structure, where the model structure is known by the receiving node, or a new model and corresponding parameters. Additionally, delivery may include a full model or a partial model.

AI model validation: A subprocess of training to evaluate the quality of a model using a dataset different from that used for model training. Validation can assist in selecting model parameters that generalize beyond the dataset used for model training.

Applicable functionalities: A subset of supported functionalities relevant to a particular scenario or node.

Additional conditions: Conditions that may vary for different scenarios, sites, or datasets. Broadly, additional conditions refer to any aspects that are assumed for training of a model but that are not part of a UE capability Examples of additional conditions include UE internal conditions such as battery, memory, hardware attributes, etc. There may be UE-side additional conditions and network-side additional conditions.

Associated identifiers (IDs): IDs referring to additional conditions. For example, UE-side additional conditions and/or network-side additional conditions may be represented by associated IDs.

Data collection: A process of collecting data by network nodes, management entities, and/or UEs for the purpose of model training, data analytics, and inference.

Dataset: A related set of information can be collectively called a dataset. Datasets may be defined for different purposes. For example, a dataset used for training may be referred to as a training dataset.

Functionality identification: A process and/or method of identifying an AI functionality for a common understanding between the network and a UE. Where an AI functionality resides (e.g., at which node) can depend on specific use cases and sub-use cases.

Management instruction: Information that can be used to ensure proper inference operation. This information may include selection, activation, deactivation, and/or switching of models and/or AI functionalities, fallback to non-AI operation, etc.

Model activation: Enabling a model for a specific AI-enabled feature.

Model deactivation: Disabling a model for a specific AI-enabled feature.

Model download: Model transfer from the network to a UE.

Model identification: A process and/or method of identifying a model for a common understanding between the network and the UE. Information regarding a model may be shared during model identification.

Model monitoring: A procedure that monitors the inference performance of a model.

Model parameter update: A process of updating model parameters of a model.

Model selection: A process of selecting, for activation, a model from among multiple models associated with the same AI enabled feature. Model selection may or may not be carried out simultaneously with model activation.

Model switching: Deactivating a currently active model and activating a different model for a specific AI-enabled feature.

Model update: A process of updating model parameters and/or model structure of a model.

Model upload: Model transfer from a UE to the network.

Offline field data: Data collected from the field and used for offline training of a model.

Offline training: An AI training process where a model is trained based on a collected dataset, and where the trained model is later used or delivered for inference. There may be cases that may not conform precisely to this definition but could still be categorized as offline training by commonly accepted conventions.

Online field data: Data collected from the field and used for online training of a model.

Online training: An AI training process (which can be continuous) where a model being used for inference is trained in real-time (or near real-time) with the arrival of new training samples (e.g., training data). The notion of real-time vs. non real-time can be context-dependent and can be relative to an inference timescale. There may be cases that may not conform precisely to this definition but can still be categorized as online training by commonly accepted conventions. Further, model fine tuning and/or retraining may be done via online and/or offline training.

Network-side model: A model for which inference is performed at the network.

Supported functionalities: A common understanding of functionalities operable by a UE and/or the network can be developed between the network and the UE. The functionalities can be said to be identified and/or supported.

Two-sided model: A paired model over which joint inference is performed, where joint inference includes inference performed cooperatively between the UE and the network. For instance, an initial inference portion may be performed by a UE and a remaining portion may be subsequently performed by an NE, or vice versa.

UE-side model: A model for which inference is performed at a UE.

UE state: A state of a UE can be defined as a UE state based on UE-side conditions, such as UE settings, UE internal conditions, additional conditions, a scenario, etc.

NE state: A state of an NE can be defined as a network state based on network-side conditions, such as NE settings, additional conditions, a scenario, a configuration, etc.

Scenario: A scenario can be defined as a deployment scenario that is categorized based on various factors, such as channel models (e.g., heavy line of sight/non-line of sight (LOS/NLOS) conditions, urban microcellular (UMi), urban macrocellular (UMa), indoor hotspot (InH)), outdoor/indoor UE distributions, carrier frequencies, UE speeds, antenna spacings, etc. For example, network-defined scenarios can be scenarios with network-defined dataset categorization. UE-defined scenarios can be scenarios with UE-defined dataset categorization. Examples of scenarios can include: (a) Various deployment scenarios, e.g.: UMa, UMi and others; 200 m inter-site distance (ISD) or 500 m ISD and others; same deployment, different cells with different configuration/assumption; gNB height and UE height; (b) Various outdoor/indoor UE distributions, e.g., 100%/0%, 20%/80%, and others; (c) Various UE mobility, e.g., 3 km/h, 30 km/h, 60 km/h, and others.

Configuration: A configuration may be defined as a set of parameters and settings, and may be for a UE, the network, or some combination thereof. The parameters and settings can include, for example, bandwidth, UE speed, antenna port layouts, numerology, and the like. A UE configuration may define various UE parameters, such as a quantity of UE receive beams (including a quantity of panels and UE antenna array dimensions) and a UE codebook. An NE configuration may define various NE parameters, such as a downlink transmit beam codebook (including various Set A beam(pairs), various Set B beam(pairs), and NE antenna array dimensions).

Reference is made herein to communicating data or information, such as signaling and/or communications that are transmitted or received between devices. It is to be appreciated that other terms may be used interchangeably with communicating, such as signaling, transmitting, receiving, outputting, forwarding, retrieving, obtaining, and so forth.

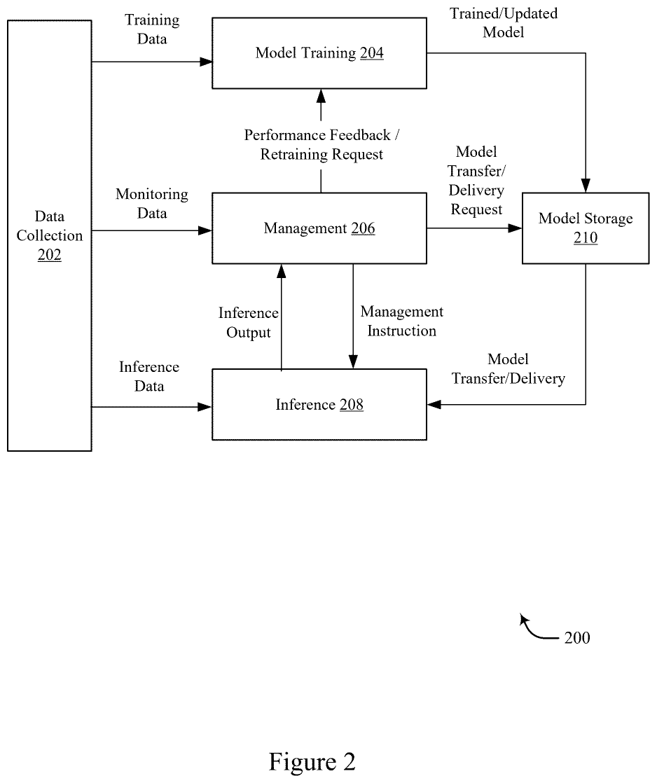

FIG. 2 illustrates an example of an AI functional framework 200. In some examples, the AI functional framework 200 implements or is implemented by aspects of the wireless communications system 100. For example, the AI functional framework 200 can implement aspects of, or can be implemented by, a UE and/or a NE, which may be examples of a UE 104 and a NE 102 as described with reference to FIG. 1.

The AI functional framework 200 includes a set of functionalities (e.g., AI functionalities) implemented to operate and manage one or more learning models as described herein. The set of functionalities includes a data collection function 202, a model training function 204, a management function 206, an inference function 208, and a model storage function 210. It is to be understood that the examples described herein are for the purposes of illustration and are not to be construed as limiting. For example, the AI functional framework 200 may include any quantity and combination of functionalities including functionalities not discussed herein.

The data collection function 202 can provide input data to the model training function 204, the management function 206, and the inference function 208. For example, the data collection function 202 provides training data as input for the model training function, monitoring data as input for the management function, and inference data as input for the inference function. The model training function 204 can perform model training, validation, and testing, and generates model performance metrics for use as part of model testing procedures. The model training function 204 is also responsible for data preparation (e.g., data preprocessing and cleaning, formatting, and transformation) based on the training data (e.g., as delivered by the data collection function).

Broadly, the management function 206 oversees the operation (e.g., selection, activation, deactivation, switching, fallback) and monitoring (e.g., performance monitoring) of models and/or functionalities. The management function 206 is further responsible for making decisions that ensure proper inference operation based on data received from the inference function 208 and the data collection function 202. For example, based on received data, the management function 206 can provide information, such as management instructions, as input to the inference function 208. Management instructions may include, but are not limited to, selection, activation, deactivation, and switching of models and/or functionalities, fallback to non-AI operations (e.g., no longer relying on inference processes), and the like. The management function 206 may input model transfer and/or delivery requests to the model storage function 210 to request model(s) from the model storage function 210. Additionally, or alternatively, the management function 206 can input performance feedback and/or retraining requests to the model training function 204, e.g., for model training, re-training, or updating purposes.

The inference function 208 provides outputs obtained from the process of applying models and/or functionalities using the data input by the data collection function 202 (also referred to herein as inference data). The inference function 208 is further responsible for data preparation (e.g., data preprocessing and cleaning, formatting, and transformation) based on inference data delivered by the data collection function 202. Inference output refers to data provided by the inference function 208 to the management function 206 for monitoring the performance of models and/or functionalities. The model storage function 210 stores trained and updated models that can be used to perform the inference function 208.

One or more nodes in a wireless communications system, such as NEs 102 and UEs 104, can perform various aspects and portions of LCM for the AI functional framework 200 as described herein. For example, one or more UEs 104 may implement data collection functions 202 to collect data from the environment, such as training data, monitoring data, and inference data. In some cases, the one or more UEs 104 transfer (e.g., transmit) the collected data to a network node, such as an NE 102. The NE 102 and/or one or more of the UEs 104 may utilize the data for model training functions 204, management functions 206, and/or inference functions 208.

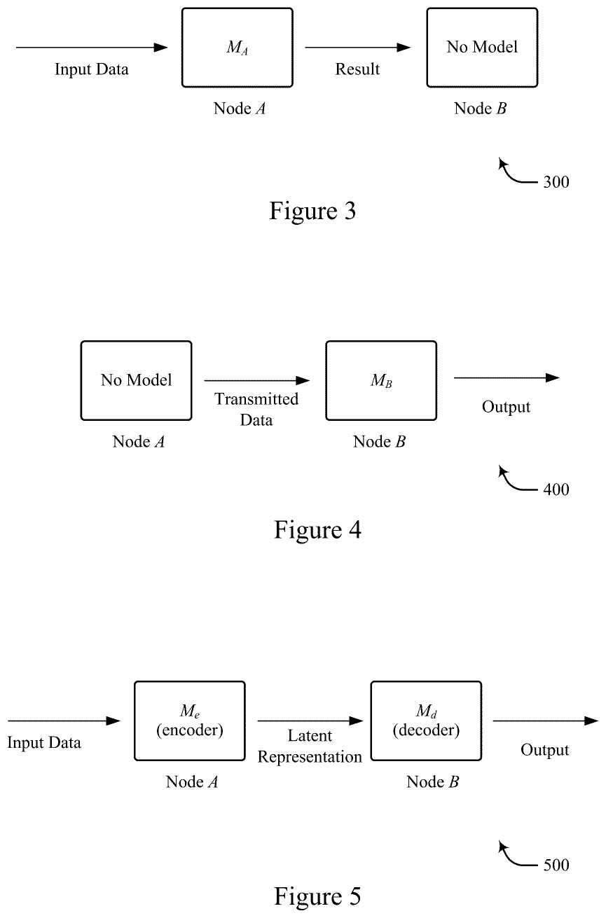

As described with reference to FIGS. 3-5, the techniques described herein support any configuration or combination of devices individually or jointly implementing models and functionalities such as those illustrated in FIG. 2. As a non-limiting example, the NE 102 may perform the model training function 204 to train a model based on data received from the UEs 104 subsequent to the UEs 104 performing the data collection function 202. The NE 102 may transfer and/or store the model (e.g., after training) using the model storage function 210. The NE 102 may additionally communicate the trained model and/or parameters for the trained model to the UEs 104, and one or more of the UEs 104 can perform the inference function 208 to obtain an inference output.

LCM of models and functionalities (e.g., AI models and functionalities) can include model-ID-based LCM and functionality-based LCM. As described herein, “functionality” refers to an AI-enabled feature/FG enabled by one or more configurations that are, in turn, supported based on conditions indicated by UE capabilities. Thus, functionality-based LCM operates based on at least one configuration of an AI-enabled feature or feature group. In functionality-based LCM, the network (e.g., an NE) indicates (e.g., to one or more other network nodes, such as UEs and/or NEs) selection, activation, deactivation, fallback, and switching of functionalities via 3GPP signaling (e.g., RRC, MAC-CE, DCI). Models may not be identified at the network, and UEs may perform model-level LCM. A UE may have one or more models for a functionality. Functionality identification may be achieved by defining one or more functionalities within an AI-enabled feature (e.g., a feature where AI may be used). Whether and how much awareness and/or interaction the network should have about model-level LCM at a UE may require further study. Additionally, mechanisms and parameters for UE reporting of updates on applicable functionalities, where applicable functionalities include a subset of all functionalities, may be studied.

In model-ID-based LCM, models are identified at the network, and the network and/or a UE may activate, deactivate, select, and switch individual models via model IDs. Model-ID-based LCM operates based on identified models, where a model may be associated with particular configurations and/or conditions associated with UE capability of an AI-enabled feature/FG, and with additional conditions (e.g., scenarios, sites, datasets) as determined or identified between the UE and the network. A model may be assigned a model ID during model identification, which may be communicated between nodes. A model ID can be used within functionalities and for different data/information/instruction flows to identify an AI/ML model. For example, a model ID may be associated with selection/(de)activation/switching of a model or linked to model transfer/delivery information associated with the model.

Additionally, once a model is identified, a UE may indicate model IDs for a given functionality or feature, e.g., as part of UE capability reporting. A model ID may or may not be globally unique, and different types of model IDs may be created for a single model for different LCM purposes. Once a functionality and/or a model is identified, the same or similar procedures may be used for activation, deactivation, switching, fallback, and monitoring. In some examples, a model ID can be used in a functionality for LCM operations. Further study may be useful regarding handling the impact of UE internal conditions (e.g., memory, battery, and other hardware limitations) on functionality and/or model operations and AI-enabled features.

Data collection (e.g., the data collection function 202) may be performed for various purposes in LCM, such as training, inference, monitoring, selection, updates, and the like. Data collection can involve performing measurements, obtaining data associated with or otherwise based on the measurements, logging the data, and reporting the data. A UE may report data periodically, on-demand (e.g., dynamically), and/or based on a trigger event, such as upon request by an NE. For instance, the UE may measure and collect data and may log the data until the data is reported.

Each instance of data collection may be performed according to different parameters. For offline model training (e.g., one- and two-sided model training), there may be no latency requirements for data collection. In contrast, when collected data used for a function is received from another entity or node, latency requirements may be applicable. For instance, latency requirements may exist for data collection associated with inference and performance monitoring (e.g., real-time performance monitoring) when the corresponding data originates at another entity or node.

In some use cases it can be assumed that the analysis and/or selection of data collection frameworks can be based on the RRC_CONNECTED state, e.g., for both data generation and reporting. Analysis and potential enhancement of the non-connected state can be revisited when appropriate.

At least the following aspects, if applicable, can be considered along with the corresponding specification impact: Measurement configuration and reporting; contents, type, and format of data including data related to model input, data related to ground-truth, quality of the data, and/or other information; signaling of assistance information for categorizing the data (e.g., considering the feasibility of disclosure of proprietary information); and/or signaling for data collection procedures. Existing specifications support downlink positioning reference signal (PRS) measurements and UE positioning in both RRC_CONNECTED and RRC_INACTIVE states.

For AI-enabled features/FGs, the term “additional conditions” can refer to aspects that are assumed for the training of a model but are not a part of UE capability for the AI-enabled features/FGs and may not imply that additional conditions are specified. Additional conditions can be divided into two categories: network-side additional conditions and UE-side additional conditions. For inference for UE-side models, to ensure consistency between training and inference regarding network-side additional conditions, the following options can apply: Model identification to achieve alignment on the network side additional condition between network side and UE side; model training at network and transfer to UE, where the model has been trained under the additional condition; information and/or indication on network side additional conditions can be provided to UE; consistency assisted by monitoring by UE and/or network, the performance of UE side candidate models and/or AI/ML functionalities to select a model and/or functionality; other approaches are not precluded.

The AI functional framework 200 enables application of AI features and functionalities at a node (e.g., a UE, an NE). As part of UE capability and UE assistance information (UAI) procedures, a UE indicates AI functionalities/use-cases/sub-use-cases (e.g., temporal beam management, CSI prediction, etc.) that it supports for inference. This UE capability information may be signaled autonomously by the UE and/or in response to reception of a capability request transmitted by the network (e.g., an NE). Additionally, as described herein, a UE can signal a readiness score indicative of the UE's preparedness to perform tasks associated with one or more AI functionalities, one or more LCM functions (e.g., a data collection function 202, a model training function 204, a management function 206, and/or an inference function 208, among other examples), or some combination thereof.

FIGS. 3 and 4 illustrate block diagrams 300 and 400, respectively, for one-sided models associated with a node A and a node B. In some examples, the one-sided models illustrated by the block diagrams 300 and 400 implement or are implemented by aspects of the wireless communications system 100. The one-sided models in the block diagrams 300 and 400, for instance, are implemented by a node A and a node B, respectively, which each may be examples of a UE 104 or an NE 102 as described with reference to FIG. 1. For example, the one-sided models in the block diagrams 300 and 400 can be implemented for use cases such as beam management, CSI prediction, radio resource management (RRM) measurement prediction, radio link failure prediction, handover failure prediction, positioning, and the like.

In the block diagram 300, the node A can implement a model M_{A} and the node B may not implement a model, e.g., may not include AI/ML capability. As a non-limiting example, the node A may be a UE that receives input data (e.g., by performing data collection or by receiving data from another node) for the model M_{A}, performs inference using the model M_{A}, and communicates a result (e.g., an output) of the inference to the node B (e.g., an NE).

In the block diagram 400, the node A may not implement a model (e.g., may not include AI/ML capability) and the node B can implement a model M_{B}. As a non-limiting example, the node A may be a UE that collects and transmits data to the node B. The node B performs inference using the model M_{B} to obtain an output.

Regarding inference, a model may be referred to as a UE-side model when the UE performs the inference (e.g., as illustrated in the block diagram 300). A model may be referred to as a network-side model when inference is performed by the network (e.g., as illustrated in the block diagram 400).

FIG. 5 illustrates a block diagram 500 for a two-sided model. In some examples, the two-sided model illustrated by the block diagram 500 implements or is implemented by aspects of the wireless communications system 100. The two-sided model in the block diagram 500 may be implemented by a node A and a node B, which each may be examples of a UE 104 or an NE 102 as described with reference to FIG. 1.

In two-sided models, a first portion of a model can be located at a first node and a second portion of the model can be located at a second node. The first portion of the model may include or be an example of an encoding model and the second portion of the model may include or be an example of a decoding model. In the block diagram 500, for example, the node A may be a UE that includes an encoding model Mₑ. The node B may be an NE that includes a decoding model M_{d}. The examples described herein are not to be construed as limiting, and the location of the encoder model and the decoder model may be alternated.

The node A may receive input data (e.g., by performing data collection or by receiving data from another node). As an example, the input data may be a dataset based on channel measurements. For example, the dataset may be raw channel inputs of H^{k} or Hₗ^{k}, or precoders that are computed from the channel matrix, e.g., the eigenvector associated with the largest eigen-vector of H^{k} for each subband. The node A may implement the encoding model Mₑ to compute a quantized latent representation of the input data and may transmit or otherwise communicate the latent representation to the node B. The node B can receive the latent representation and use the latent representation to reconstruct an output by implementing the decoding model M_{d}.

Models may be tailored toward and applicable to specific scenarios, configurations, locations, and deployments, among other factors. In this regard, models may undergo updates (e.g., model changes) as part of their development. As such, after model training, there may be multiple models at the node A side that are associated with different node Bs, and multiple models at the node B side that are associated with different node As.

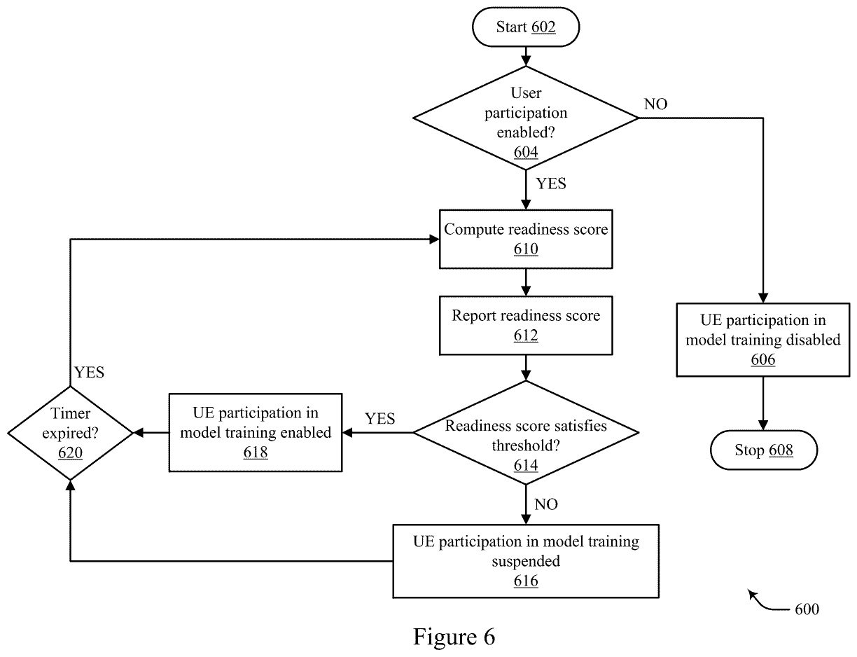

FIG. 6 illustrates an example process flow 600 in accordance with aspects of the present disclosure. In some examples, the process flow 600 implements or is implemented by aspects of the wireless communications system 100. For example, operations of the process flow 600 may be implemented by a UE and/or an NE, which each may be examples of a UE 104 or an NE 102 as described with reference to FIG. 1. The process flow 600 illustrates an example in which a UE indicates, to a network node (e.g., a base station, a network entity, a network function, etc.), a readiness of the UE and consent (e.g., authorize, permit, acknowledge, opt-in) to participate in model training. As described herein, participation in model training refers to training-related processes, tasks, etc. in which the UE is involved, such as data collection (e.g., measuring, collecting, logging, and/or reporting data relevant to model training). In some examples, the UE is provided (e.g., by the NE) with a configuration for one or more tasks associated with model training. For instance, the NE may transmit, to the UE, signaling including a set (e.g., list, group, table) of functionalities for model training or a set (e.g., list, group, table) of data collection tasks for the UE to perform. In response, the UE can provide an acknowledgment (e.g., acceptance, rejection) for each functionality or data collection task in the received set (e.g., list, group, table) of functionalities/data collection tasks.

For example, the UE may compute a readiness score based on one or more parameters (e.g., factors) that contribute to an overall readiness of the UE for model training-related tasks. These parameters can impact the UE's performance and capacity to measure, collect, and/or transfer data for model training. Thus, the readiness score may represent (e.g., indicate, correspond to) how fit, able, and prepared the UE is to take part in AI/ML-related data collection for different LCM functions such as model training. The readiness score testifies, to the NE (e.g., and/or to a network to which the NE and the UE belong), if, why, and how much the UE's capacity is to bear the data collection burden. In some examples, the UE may compute the readiness score as a binary indicator corresponding to whether the UE is to participate in the model training. For example, a first value (e.g., 1) of the readiness score corresponds to the UE being ready and prepared to participate in the model training, and a second value (e.g., 0) of the readiness score corresponds to the UE being unable or unprepared to participate in the model training.

Based on the readiness score, the NE and/or the UE may decide whether (and, in some cases, to what extent) the UE is to participate in the model training. For example, the UE may be configured (e.g., by the NE) to autonomously make such a decision. In such examples, the UE may analyze the readiness score (e.g., based on the value of the readiness score and/or by comparing the readiness score to a threshold, such as a configured threshold) to determine whether to participate. The UE may transmit an indication of the decision and/or the readiness score to the NE, e.g., as part of a report. Additionally, or alternatively, the NE may analyze the readiness score (e.g., based on the value of the readiness score and/or by comparing the readiness score to a threshold, such as a configured threshold) to determine whether the UE is to participate in the model training. Based on this decision, the NE can transmit instructions to the UE indicating whether the UE is to participate or to refrain from participating. In some examples, the NE may additionally or alternatively transmit a task configuration or a task reconfiguration for tasks associated with the model training, e.g., for the UE to perform.

The one or more parameters may include a hardware capability of the UE, a hardware configuration of the UE, a battery status of the UE (e.g., whether the battery has sufficient power to perform model training and/or a battery level of the UE), whether the UE is roaming, a buffer status of the UE, a buffer size of the UE, an available processing power of the UE, and/or a status of one or more existing tasks or processes being performed by the UE, among other examples. For instance, a hardware capability and/or a hardware configuration may impact whether the UE is able to participate in model training tasks, e.g., based on task configurations associated with the model training tasks. A buffer status can correspond to a relative amount of data queued or otherwise pending in a buffer of the UE, such as a logging buffer associated with data collection, a lower-layer (e.g., MAC) data transfer buffer, or the like. If the buffer has a large amount of data relative to the buffer's size, the UE may not be capable of performing model training tasks. As another example, the UE may not be able to perform model training tasks if the UE does not have sufficient processing power available. In some cases, a lack of available processing power can occur due to other tasks being performed at the UE, such as other data collection processes or tasks resulting from a user operating the UE. Thus, the UE can compute the readiness score at least partially based on whether (e.g., and how much) available processing power exists and/or whether other tasks are currently being performed by the UE.

In some examples, participation of the UE in model training (e.g., for different use cases) can be enabled, disabled, or suspended by the user. This feature can be realized by implementing user participation in model training as an optional feature. For instance, the user can dynamically enable or disable participation in the UE's system settings, and the UE can compute and report its readiness score to the NE accordingly. The UE may be configured with a particular value of a readiness score or indicator corresponding to the participation being disabled by the user, such as a value of zero for an average or respective readiness score. In some cases, this feature may be designed per use-case/sub-use-case, which may provide the user with flexibility to decide which use cases/sub-use-cases the UE will contribute to. Alternatively, this feature may be correspond to model training overall, e.g., as a Boolean indicator. For example, a value of 0 may indicate that participation is disabled, while a value of 1 may indicate that participation is enabled.

In an example implementation, the enabling and disabling of user participation in model training can be achieved as a subscription feature. Different options for the subscription can be provided to the user. A subscription to participate in model training can be, for example, a weekly, monthly, or yearly package. To attract more users to participate in model training, the user may receive an incentive for enabling participation. The user may subscribe and/or unsubscribe to AI/ML model training. In some cases, enabling and/or disabling participation may occur following a time duration (e.g., a notice period), such that the NE can be informed of the user's decision in advance. The configuration of the notice period to unsubscribe can be up to implementation or up to SLA between the UE vendor, chipset vendor, and the operator. Alternatively, the user may have the option to subscribe and/or unsubscribe to participation for individual use cases. Different selection choices can be presented to the user in the form of user incentives, types of data, training and/or data collection duration, etc. It can be up to the NE or to UE internal processing to map these user demands to the respective use cases.

While the process flow 600 is described with reference to model training, the techniques described herein can be applied to any category or granularity of tasks and operations associated with AI/ML, such as functionalities, models, LCM operations (e.g., LCM functions, also referred to herein as LCM functionalities or functionalities associated with LCM), and so forth. In some implementations, for example, the readiness score may correspond to the UE's readiness for a particular type or task of model training, or to model training overall. Additionally, or alternatively, the readiness score may correspond to one or more tasks, one or more models (e.g., as identified by a model ID), one or more functionalities (e.g., AI functionalities), one or more use-cases or sub-use-cases, one or more LCM operations (e.g., model training, inference, monitoring, etc.), the one or more parameters, or any combination thereof. In some cases, the UE may compute multiple readiness scores, each readiness score corresponding to a respective functionality (e.g., an AI functionality), LCM operation, or parameter of the one or more parameters.

Additionally, while the process flow 600 is described with reference to communication between a UE and an NE, the techniques described herein support any configuration or combination of devices individually or jointly performing the operations of the process flow 600. For instance, a UE may report a readiness score to another UE operating as a relay UE, where the relay UE transmits the received readiness score to the NE. As another non-limiting example, the NE may serve a group of UEs. Each UE in the group of UEs may report a respective readiness score to a designated primary UE, which may aggregate and relay the respective readiness scores to the NE. Other devices or types of devices may perform the techniques described herein, and the examples shown are not to be construed as limiting.

At 602, the UE begins a process for determining its readiness to participate in model training (e.g., in one or more tasks associated with model training).

At 604, if the UE enables user participation, the UE determines whether the user has enabled or disabled the UE's participation in the model training. For instance, at 606, the UE may determine that the user has disabled the UE's participation, and the UE may stop the process at 608. Alternatively, if the UE determines that the user has enabled the UE's participation in the model training, the UE may compute the readiness score at 610.

At 612, based on the computing, the UE transmits a report indicating the readiness score(s) to the NE. For example, the UE may transmit an indication of the readiness score to the NE via UE capability information, UE assistance information (UAI), RRC signaling, or a MAC-CE. In some examples, the UE reports actual values of the readiness score(s), while in other examples, the UE reports indicators (e.g., bit indicators) corresponding to the readiness score(s). In some cases, for scenarios in which the UE computes multiple readiness scores (e.g., at 610), the UE may further compute an average readiness score from the multiple readiness scores. The UE can include an indication of the average readiness score in the report.

Additionally, or alternatively, the UE may indicate the multiple readiness scores, e.g., as individual readiness scores corresponding to respective tasks, models, functionalities, LCM operations, etc. For example, the UE may include, in the report, a bitmap, where each bit of the bitmap corresponds to a respective task, model, functionality, LCM operation, or the like. In such examples, a value of each bit may be indicative of the UE's readiness to support the corresponding task, model, functionality, or LCM operation. As an example, the UE may indicate, as a Boolean variable, a respective readiness score for each LCM operation of a set of LCM operations (e.g., training, inference, monitoring, etc.), where a first value (e.g., 1) of a respective readiness score (e.g., a respective bit of the bitmap, the bit corresponding to the respective readiness score) indicates that the UE is ready to implement the corresponding operation and a second value (e.g., 0) of the respective readiness score corresponds to the UE being unprepared to implement the corresponding operation. Alternatively, each indicator and/or bit may represent the UE's readiness to perform an LCM operation for a given functionality. For instance, the UE may indicate a first Boolean variable corresponding to model training for beam management and a second Boolean variable corresponding to inference for beam management.

As another example, at 610, the UE may compute a respective readiness score for each parameter of the set of parameters, where the respective readiness score indicates the UE's readiness based on the corresponding parameter. At 612, the UE may report the individual readiness scores as a bitmap, where each parameter is associated with a respective bit having a bit value indicative of the corresponding readiness score. Additionally, each bit (e.g., each parameter) may be associated with a respective quantization (e.g., according to a quantization scheme). For instance, for three parameters (e.g., battery status, buffer size, and hardware configuration), each parameter may be assigned three (3) bits. The UE can report an average readiness score based on the respective readiness scores or can report the respective readiness scores for each parameter individually, such that the report includes nine (9) total bits. In some cases, a simplified scheme such as factor analysis can be applied if additional relevant parameters are realized. Additionally, or alternatively, at 610, the UE may compute an average readiness score based on the respective readiness scores and may report the average readiness score to the NE at 612. In yet another implementation, at 612, the UE may report actual values of the individual readiness scores, e.g., as assistance information, such that the NE can evaluate the readiness of the UE based on the reported actual values.

To ensure that the NE is able to interpret the implication of indicated readiness scores, e.g., for a given parameter, the NE may provide the UE with a report configuration designating aspects according to which the UE is to transmit the report. For example, the NE may transmit control signaling (e.g., RRC, MAC-CE) to the UE indicating the report configuration. The report configuration can indicate a periodicity according to which the UE is to transmit the report, one or more trigger events (e.g., a change in a value of a readiness score, a determination that the readiness score satisfies a threshold, reception of a request to perform the model training, reception of a request to report the readiness score, expiry of a timer, etc.) for transmitting the report, or the like. Additionally, or alternatively, the NE can configure and/or request the UE to proactively report the readiness score.

For example, the UE may be configured to report the readiness score at 612 (e.g., and/or to compute the readiness score at 610) in response to a trigger event. For instance, the trigger event may be the UE receiving (e.g., from the NE) an explicit request for the report, and the UE transmits the report in response to the request. Additionally, or alternatively, the trigger event may be the UE receiving (e.g., from the NE) a request for the UE to perform the one or more tasks, such as data collection or another AI/ML LCM-related request, and the UE transmits the report in response to the request. Such requests may originate from the NE, a CN entity/OAM, or an external server. In an alternate implementation, the UE reports the readiness score upon being reconfigured by the network. In yet another implementation, the UE transmits the readiness score when the UE transitions from the RRC Idle/Inactive state to the RRC connected state.

Additionally, or alternatively, the trigger event may be a determination, by the UE, that the readiness score satisfies a threshold. For instance, the UE may periodically compute the readiness score and compare the readiness score to a threshold, which may be indicated in the report configuration. When the UE detects that the readiness score satisfies the threshold, the UE may transmit the report. As another example, the trigger event may be any change in a value of the readiness score, e.g., to enable the UE to update the readiness score at the NE. For instance, the UE may be configured to report such updates for all configured data collection(s)/functionalities, or for one or more specific functionalities/data collection configurations whose readiness score has changed compared to a previous report. Any combination of the configurations described herein may also be achieved. For instance, the UE may be configured to report the readiness score if a change in the readiness score satisfies a threshold, e.g., if a readiness score falls above or below a previously-computed readiness score. Thus, the UE may periodically compute and assess the readiness score to determine whether to transmit a report (e.g., at 612).

Additionally, or alternatively, the report configuration may include instructions for how the UE is to compute and/or indicate the readiness score, e.g., at 610 and 612, respectively. For instance, the report configuration may indicate the type of readiness score the UE is to compute, such as readiness scores for parameters, functionalities, LCM operations, etc., whether the UE is to compute an average readiness score or individual readiness scores, and the like. As another example, the report configuration may indicate one or more quantization schemes and/or one or more bit quantities for transmitting the indication(s) of the readiness score(s). It should be noted that the overall granularity of reporting the readiness score is not limited to and can be extended per functionality, use-case/sub-use-case, configuration of a functionality, data collection task, or data collection configuration provided by the network. The granularity can be requested and/or selected by the UE or may be configured by the network, e.g., via the NE.

Example implementations are presented below to illustrate computation and reporting of readiness scores based on one or more parameters. These examples are equally applicable to readiness scores based on or associated with other aspects, such as functionalities, LCM operations, and so forth. Quantization and the computation of readiness scores can be achieved in different ways or, in some cases, can be left up to implementation. The quantization of the readiness score can be implemented by assigning 2-bit, 3-bit, or 4-bit indicators to each parameter of the one or more parameters. For instance, the NE may configure the UE to report one factor with a 2-bit quantization while the other factors with a 4-bit quantization.

### Example 1

In example 1, the parameters for which the UE calculates readiness scores include a battery, a buffer size, and a hardware configuration. As shown in Table 1 below, the quantization scheme is 2 bits and is common for all parameters.

TABLE 1
Quantization Scheme

| Range | Quantized value | Bit indication |
|---|---|---|
| 1-25% | 0 | 00 |
| 26-50% | 1 | 01 |
| 51-75% | 2 | 10 |
| 76-100% | 3 | 11 |

Table 2 below shows the readiness scores computed for each parameter.

TABLE 2
Readiness Scores

| Battery | Buffer size | Hardware configuration |
|---|---|---|
| 2 | 1 | 3 |

In some cases, at 610, the UE may compute an “overall” readiness score indicative of the UE's overall readiness to perform model training tasks by computing an average readiness score of the individual readiness scores. In Example 1, based on the readiness scores shown in Table 2, the overall readiness score may be equal to 2. Using the quantization scheme shown in Table 1, the UE may transmit, at 612, a report indicating the overall readiness score as a bit indication of 10.

### Example 2

In example 2, the parameters for which the UE calculates readiness scores include a battery, a buffer size, and a hardware configuration. As shown in Table 3 below, the UE is configured with an individual quantization scheme for each parameter.

TABLE 3
Quantization Schemes

| Factors | Quantization | Range | Quantized value | Binary indicator |
|---|---|---|---|---|
| Battery | 1-bit | <51% | 0 | 0 |
| | | >50% | 1 | 1 |
| Buffer size | 2-bits | 1-25% | 0 | 00 |
| | | 26-50% | 1 | 10 |
| | | 51-75% | 2 | 01 |
| | | 76-100% | 3 | 11 |
| Hardware | 3-bits | 1-12.5% | 0 | 000 |
| configuration | | 12.6-25% | 1 | 001 |
| | | . | . | . |
| | | . | . | . |
| | | . | . | . |
| | | 87.5-100% | 7 | 111 |

Table 4 below shows the readiness scores computed for each parameter.

TABLE 4
Readiness Scores

| Battery | Buffer size | Hardware configuration |
|---|---|---|
| 1 | 2 | 7 |

In example 2, the UE may compute, at 610, an individual readiness score for each parameter as shown in Table 4. The UE may transmit, at 612, a report including a respective binary indicator for each parameter according to the quantization scheme shown in Table 3.

In some examples, the UE may additionally or alternatively communicate information relevant to data collection to the NE. For example, the UE may include such information in UE capability reporting (e.g., similar to other supported functionalities). The UE may utilize an information element (IE) (e.g., AIML-training-list) for training-related functionalities. Here, the UE indicates, in the IE, a list of all functionalities for which the UE supports training, implying that the UE can participate in training of the listed functionalities if configured as such by the NE.

As another example, UE capability reporting may be utilized to indicate an overall preparedness of the UE to participate in model training for the listed functionalities. The UE can report AIML-training-list in an RRC message, such as a dedicated RRC message for reporting AI/ML-related UE capabilities. This allows the UE to dynamically signal its readiness information to the NE upon any change in the listed functionalities.

Alternatively, existing RRC messages can be extended for use in configuring the UE and in reporting the readiness score. For example, the NE can utilize an RRC message associated with a measurement configuration framework to indicate the report configuration to the UE. In response, the UE may utilize an RRC message associated with a measurement reporting framework to transmit the report. Alternatively, the UE can report the readiness score using other uplink RRC messages. Similarly, UAI can be extended to include the signaling of the readiness score or an update in the readiness score.

In another implementation, the UE reports the readiness score to the NE relatively frequently, e.g., piggybacked with data transmission in an uplink MAC transport block using a dedicated MAC-CE or an enhanced existing MAC-CE. For instance, the UE can include the readiness score at the end of the MAC payload in place of MAC padding in the uplink MAC transport block without consuming any additional resources when the actual payload size is smaller than the allocated transport block size. The padding subheader in a subheader of the MAC can be extended and/or adapted to indicate the presence of information related to UE readiness for model training in the MAC transport block padding. Alternatively, an existing buffer status report (BSR) can be extended to report the readiness score.

The UE and/or the NE may analyze (e.g., interpret) the readiness score to assess the UE's ability to perform the one or more tasks (e.g., measuring, collecting, and transferring data for model training). In some implementations, the NE may configure a threshold for the readiness score. In some cases, the threshold may be different for each LCM function, such as model training, data collection, inference, monitoring, etc. In an example implementation, different priority levels can be considered for the LCM functions. For instance, a relatively low readiness score can be feasible for some functions that do not rely on significant processing efforts from the UE, e.g., as compared to other functions.

For example, at 614, based on the received report, the NE may determine whether (e.g., and to what extent) the UE is to participate in the model training. The NE may compute an average readiness score, e.g., if the UE reported multiple individual readiness scores. In this example, the NE may compare the indicated readiness score to a threshold. If the NE determines that the readiness score fails to satisfy the threshold, the NE can disable the UE from performing the one or more tasks, e.g., permanently or temporarily. For instance, at 616, the NE may suspend (e.g., temporarily) the UE's participation in model training by transmitting signaling to the UE instructing the UE to refrain from participating.

If the NE determines that the readiness score satisfies the threshold, the NE may enable participation of the UE in the model training, e.g., at 618. The NE may transmit signaling instructing the UE to perform the one or more tasks. Additionally, or alternatively, the NE may transmit a task configuration indicating parameters according to which the UE is to perform the one or more tasks. In some cases, based on the readiness score, the NE may determine a reconfiguration for the one or more tasks. For instance, the NE may evaluate the UE's capabilities based on the readiness score and may adjust parameters for performing the one or more tasks according to the UE's capabilities. As a nonlimiting example, an original configuration for data collection may include performing a set of measurements. The readiness score may indicate that the UE is partially capable of performing the data collection. Accordingly, the NE may reconfigure the UE to perform a subset of the measurements, such as by transmitting signaling indicating a task reconfiguration for the one or more tasks.

In some implementations, the UE may be configured (e.g., by the NE, such as via the report configuration) to compute and report the readiness score based on expiry of a timer. For example, subsequent to enabling or suspending participation in model training, the UE may determine that the timer has expired at 620. In response to the determination, the UE may again compute the readiness score as described at 610 and report the readiness score as described at 612.

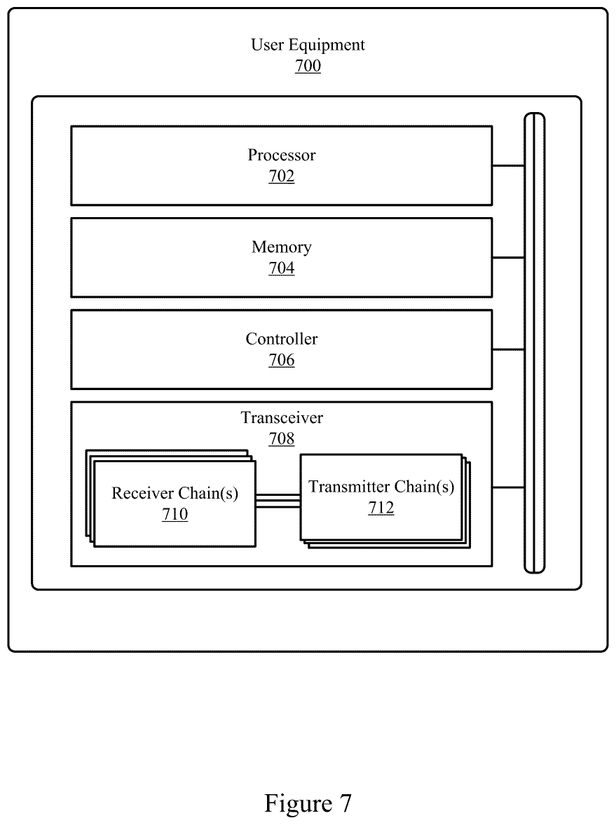

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for computing a score indicative of a readiness of the UE, to participate in one or more tasks associated with learning model training, based at least in part on UE information, and transmitting an indication of the score.

Additionally, the UE 700 may be configured to support any one or combination of the method further comprising receiving a configuration, the configuration including at least one of a quantization scheme, a quantity of bits, a periodicity, one or more trigger events, or a set of parameters for which the score is to be computed, where the indication of the score is transmitted based on the configuration. Additionally, or alternatively, the method further comprises receiving a configuration for the one or more tasks, and performing the one or more tasks based on the score and the received configuration. Additionally, or alternatively, the method further comprises participating in the learning model training based on a value of the score satisfying a threshold or refraining from participating in the learning model training based on the value of the score satisfying the threshold. Additionally, or alternatively, the method further comprises computing a respective score for each functionality of a set of functionalities associated with learning model LCM. Additionally, or alternatively, the method further comprises the indication including a bitmap, where each functionality of the set of functionalities corresponds to a respective bit value that is indicative of the readiness of the UE to support the respective functionality. Additionally, or alternatively, the method further comprises the UE information includes a set of parameters, and computing the score comprises computing a respective score for each parameter of the set of parameters. Additionally, or alternatively, the method further comprises the indication including a bitmap, where each parameter of the set of parameters corresponds to a respective bit value that is indicative of the readiness of the UE according to the respective parameter. Additionally, or alternatively, the method further comprises computing an average score based on the respective score for each parameter of the one or more parameters, where the indication represents the computed average score. Additionally, or alternatively, the method further comprises transmitting the indication of the score based on a trigger event, the trigger event including at least one of a change in a value of the readiness score, a determination that the readiness score satisfies a threshold, or a request to perform the learning model training or report the score. Additionally, or alternatively, the method further comprises the one or more tasks including collecting data, performing measurements, logging data, or reporting data. Additionally, or alternatively, the method further comprises the UE information includes a set of parameters including at least one of a battery status of the UE 700, a hardware configuration of the UE 700, a buffer status of the UE 700, or a status of an existing task being performed by the UE 700. Additionally, or alternatively, the method further comprises transmitting the indication via UE capability information, RRC signaling, or a MAC-CE.

Additionally, or alternatively, the UE 700 may support at least one memory (e.g., the memory 704) and at least one processor (e.g., the processor 702) coupled with the at least one memory and configured to cause the UE 700 to compute a score indicative of a readiness of the UE 700, to participate in one or more tasks associated with learning model training, based on UE information, and transmit an indication of the score.

Additionally, the UE 700 may be configured to support any one or combination of the at least one processor is configured to cause the UE 700 to receive a configuration, where the configuration includes at least one of a quantization scheme, a quantity of bits, a periodicity, one or more trigger events, or a set of parameters for which the score is to be computed, where the indication of the score is transmitted based on the configuration. Additionally, or alternatively, the at least one processor is further configured to cause the UE 700 to receive a configuration for the one or more tasks, and perform the one or more tasks based on the score and the received configuration. Additionally, or alternatively, the at least one processor is further configured to cause the UE 700 to participate in the learning model training based on a value of the score satisfying a threshold or refrain from participating in the learning model training based on the value of the score satisfying the threshold. Additionally, or alternatively, to compute the score, the at least one processor is further configured to cause the UE 700 to compute a respective score for each functionality of a set of functionalities associated with learning model LCM. Additionally, or alternatively, the indication includes a bitmap, and where each functionality of the set of functionalities corresponds to a respective bit value that is indicative of the readiness of the UE 700 to support the respective functionality. Additionally, or alternatively, the UE information comprises a set of parameters, and, to compute the score, the at least one processor is further configured to cause the UE 700 to compute a respective score for each parameter of the set of parameters. Additionally, or alternatively, the indication includes a bitmap, and where each parameter of the set of parameters corresponds to a respective bit value that is indicative of the readiness of the UE 700 according to the respective parameter. Additionally, or alternatively, to compute the score, the at least one processor is further configured to cause the UE 700 to compute an average score based on the respective score for each parameter of the one or more parameters, where the indication represents the computed average score. Additionally, or alternatively, the at least one processor is further configured to cause the UE 700 to transmit the indication of the score based on a trigger event, the trigger event including at least one of a change in a value of the score, a determination that the score satisfies a threshold, or a request to perform the learning model training or report the score. Additionally, or alternatively, the one or more tasks include collecting data, performing measurements, logging data, or reporting data. Additionally, or alternatively, the UE information includes a set of parameters including at least one of a battery status of the UE 700, a hardware configuration of the UE 700, a buffer status of the UE 700, or a status of a current task performed by the UE 700. Additionally, or alternatively, to transmit the indication of the score, the at least one processor is configured to cause the UE 700 to transmit the indication via UE capability information, RRC signaling, or a MAC-CE.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

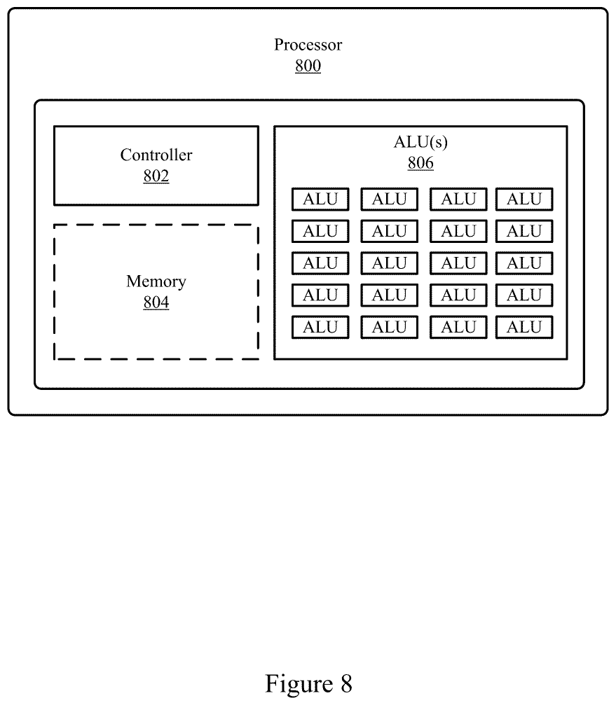

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to compute a score indicative of a readiness of the processor 800, to participate in one or more tasks associated with learning model training, based on processor information, and transmit an indication of the score.

Additionally, the processor 800 may be configured to support any one or combination of the at least one controller is configured to cause the processor 800 to receive a configuration, where the configuration includes at least one of a quantization scheme, a quantity of bits, a periodicity, one or more trigger events, or a set of parameters for which the score is to be computed, where the indication of the score is transmitted based on the configuration. Additionally, or alternatively, the at least one controller is further configured to cause the processor 800 to receive a configuration for the one or more tasks, and perform the one or more tasks based on the score and the received configuration. Additionally, or alternatively, the at least one controller is further configured to cause the processor 800 to participate in the learning model training based on a value of the score satisfying a threshold or refrain from participating in the learning model training based on the value of the score satisfying the threshold. Additionally, or alternatively, to compute the score, the at least one controller is further configured to cause the processor 800 to compute a respective score for each functionality of a set of functionalities associated with learning model LCM. Additionally, or alternatively, the indication includes a bitmap, and where each functionality of the set of functionalities corresponds to a respective bit value that is indicative of the readiness of the processor 800 to support the respective functionality. Additionally, or alternatively, the processor information comprises a set of parameters, and, to compute the score, the at least one controller is further configured to cause the processor 800 to compute a respective score for each parameter of the set of parameters. Additionally, or alternatively, the indication includes a bitmap, and where each parameter of the set of parameters corresponds to a respective bit value that is indicative of the readiness of the processor 800 according to the respective parameter. Additionally, or alternatively, to compute the score, the at least one controller is further configured to cause the processor 800 to compute an average score based on the respective score for each parameter of the one or more parameters, where the indication represents the computed average score. Additionally, or alternatively, the at least one controller is further configured to cause the processor 800 to transmit the indication of the score based on a trigger event, the trigger event including at least one of a change in a value of the score, a determination that the score satisfies a threshold, or a request to perform the learning model training or report the score. Additionally, or alternatively, the one or more tasks include collecting data, performing measurements, logging data, or reporting data. Additionally, or alternatively, the processor information includes a set of parameters including at least one of a battery status of the processor 800, a hardware configuration of the processor 800, a buffer status of the processor 800, or a status of a current task performed by the processor 800. Additionally, or alternatively, to transmit the indication of the score, the at least one controller is configured to cause the processor 800 to transmit the indication via UE capability information, RRC signaling, or a MAC-CE.

In some examples, the processor 800 may support wireless communication at an NE in accordance with examples as disclosed herein. The processor 800 may be configured to or operable to support at least one controller (e.g., the controller 802) coupled with at least one memory (e.g., the memory 804) and configured to cause the processor 800 to receive, from a UE, an indication of a score indicative of a readiness of the UE, to participate in one or more tasks associated with learning model training, based on UE information, and transmit a configuration for the one or more tasks based on the score.

Additionally, the processor 800 may be configured to or operable to support any one or combination of the indication includes a bitmap, the UE information includes a set of parameters, each parameter of the set of parameters corresponds to a respective bit value that is indicative of the readiness of the UE according to the respective parameter, and the at least one controller is configured to cause the processor 800 to compute an average score for the UE based on the indication. Additionally, or alternatively, the at least one controller is configured to cause the processor 800 to transmit signaling instructing the UE to perform the one or more tasks based on the average score. Additionally, or alternatively, the indication includes a bitmap, the UE information includes a set of functionalities associated with learning model life cycle management, each functionality of the set of functionalities corresponds to a respective bit value that is indicative of the readiness of the UE to support the respective functionality, and the at least one controller is configured to cause the processor 800 compute an average score for the UE based on the indication. Additionally, or alternatively, the at least one controller is configured to cause the processor 800 to transmit signaling instructing the UE to perform the one or more tasks based on the average score. Additionally, or alternatively, the one or more tasks include collecting data, performing measurements, logging data, or reporting data. Additionally, or alternatively, the UE information includes a set of parameters including at least one of a battery status of the UE, a hardware configuration of the UE, a buffer status of the UE, or a status of a current task being performed by the UE. Additionally, or alternatively, the at least one controller is configured to cause the processor 800 to receive the indication of the score via UE capability information, RRC signaling, or a MAC-CE. Additionally, or alternatively, the at least one controller is configured to cause the processor 800 to transmit signaling indicating a configuration, where the configuration includes at least one of a quantization scheme, a quantity of bits, a periodicity, one or more trigger events, or a set of parameters for which the score is to be computed, where the indication of the score is received in accordance with the configuration. Additionally, or alternatively, the at least one controller is configured to cause the processor 800 to transmit a task reconfiguration for the one or more tasks based on the score.

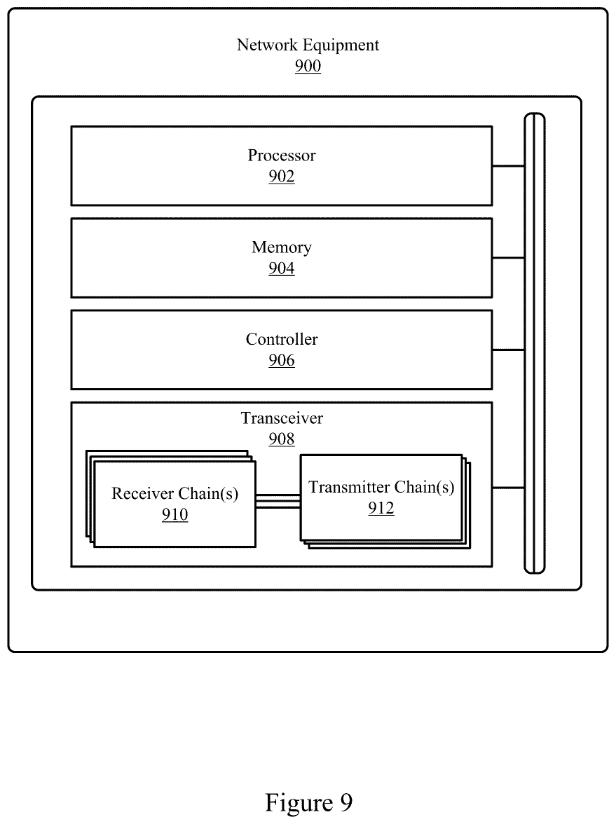

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for receiving, from a UE, an indication of a score indicative of a readiness of the UE, to participate in one or more tasks associated with learning model training, based on UE information, and transmitting a configuration for the one or more tasks based on the score.

Additionally, the NE 900 may be configured to or operable to support any one or combination of the indication includes a bitmap, the UE information includes a set of parameters, each parameter of the set of parameters corresponds to a respective bit value that is indicative of the readiness of the UE according to the respective parameter, and the method further includes computing an average score for the UE based on the indication. Additionally, or alternatively, the method further includes transmitting signaling instructing the UE to perform the one or more tasks based on the average score. Additionally, or alternatively, the indication includes a bitmap, the UE information includes a set of functionalities associated with learning model life cycle management, each functionality of the set of functionalities corresponds to a respective bit value that is indicative of the readiness of the UE to support the respective functionality, and the method further includes computing an average score for the UE based on the indication. Additionally, or alternatively, the method further includes transmitting signaling instructing the UE to perform the one or more tasks based on the average score. Additionally, or alternatively, the one or more tasks include collecting data, performing measurements, logging data, or reporting data. Additionally, or alternatively, the UE information includes a set of parameters including at least one of a battery status of the UE, a hardware configuration of the UE, a buffer status of the UE, or a status of a current task being performed by the UE. Additionally, or alternatively, the method further includes receiving the indication of the score via UE capability information, RRC signaling, or a MAC-CE. Additionally, or alternatively, the method further includes transmitting signaling indicating a configuration, where the configuration includes at least one of a quantization scheme, a quantity of bits, a periodicity, one or more trigger events, or a set of parameters for which the score is to be computed, where the indication of the score is received in accordance with the configuration. Additionally, or alternatively, the method further includes transmitting a task reconfiguration for the one or more tasks based on the score.

Additionally, or alternatively, the NE 900 may support at least one memory (e.g., the memory 904) and at least one processor (e.g., the processor 902) coupled with the at least one memory and configured to cause the NE 900 to receive, from a UE, an indication of a score indicative of a readiness of the UE, to participate in one or more tasks associated with learning model training, based on UE information, and transmit a configuration for the one or more tasks based on the score.

Additionally, the NE 900 may be configured to support any one or combination of the indication includes a bitmap, the UE information includes a set of parameters, each parameter of the set of parameters corresponds to a respective bit value that is indicative of the readiness of the UE according to the respective parameter, and the at least one processor is configured to cause the NE 900 to compute an average score for the UE based on the indication. Additionally, or alternatively, the at least one processor is configured to cause the NE 900 to transmit signaling instructing the UE to perform the one or more tasks based on the average score. Additionally, or alternatively, the indication includes a bitmap, the UE information includes a set of functionalities associated with learning model life cycle management, each functionality of the set of functionalities corresponds to a respective bit value that is indicative of the readiness of the UE to support the respective functionality, and the at least one processor is configured to cause the NE 900 to compute an average score for the UE based on the indication. Additionally, or alternatively, the at least one processor is configured to cause the NE 900 to transmit signaling instructing the UE to perform the one or more tasks based on the average score. Additionally, or alternatively, the one or more tasks include collecting data, performing measurements, logging data, or reporting data. Additionally, or alternatively, the UE information includes a set of parameters including at least one of a battery status of the UE, a hardware configuration of the UE, a buffer status of the UE, or a status of a current task being performed by the UE. Additionally, or alternatively, the at least one processor is configured to cause the NE 900 to receive the indication of the score via UE capability information, RRC signaling, or a MAC-CE. Additionally, or alternatively, the at least one processor is configured to cause the NE 900 to transmit signaling indicating a configuration, where the configuration includes at least one of a quantization scheme, a quantity of bits, a periodicity, one or more trigger events, or a set of parameters for which the score is to be computed, where the indication of the score is received in accordance with the configuration. Additionally, or alternatively, the at least one processor is configured to cause the NE 900 to transmit a task reconfiguration for the one or more tasks based on the score.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

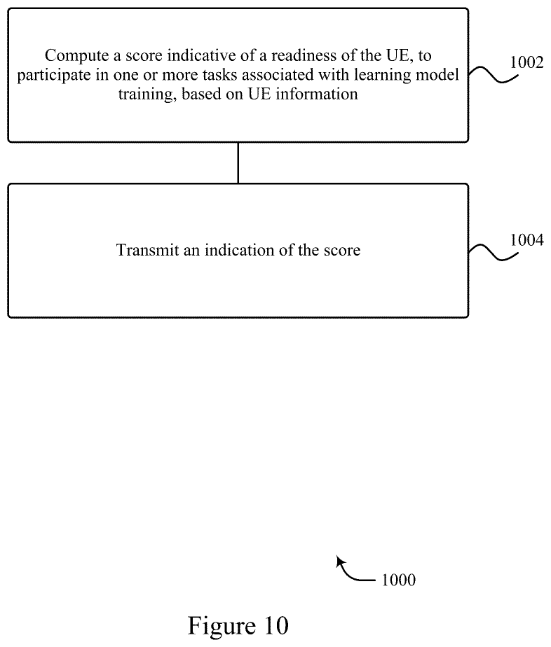

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include computing a score indicative of a readiness of the UE, to participate in one or more tasks associated with learning model training, based on UE information. The operations of 1002 may be performed in accordance with examples as described herein. In some implementations, aspects of the operations of 1002 may be performed by a UE as described with reference to FIG. 7.

At 1004, the method may include transmitting an indication of the score. The operations of 1004 may be performed in accordance with examples as described herein. In some implementations, aspects of the operations of 1004 may be performed by a UE as described with reference to FIG. 7.

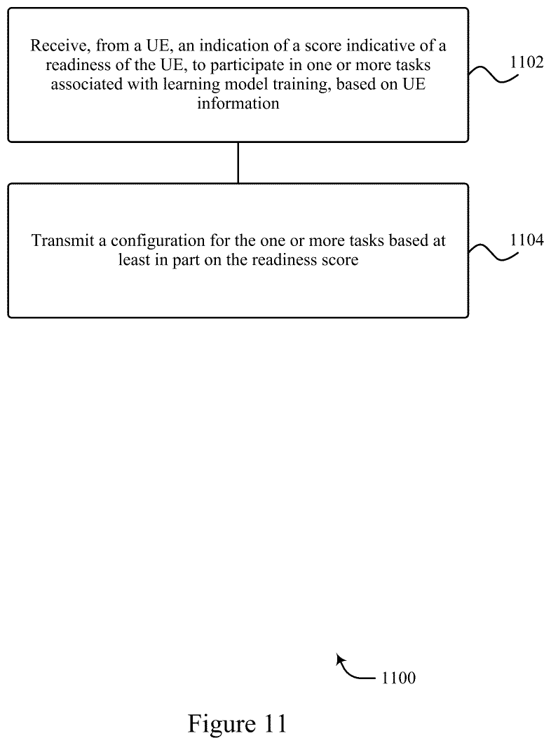

FIG. 11 illustrates a flowchart of a method 1100 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include receiving, from a UE, an indication of a score indicative of a readiness of the UE, to participate in one or more tasks associated with learning model training, based on UE information. The operations of 1102 may be performed in accordance with examples as described herein. In some implementations, aspects of the operations of 1102 may be performed by an NE as described with reference to FIG. 9.

At 1104, the method may include transmitting a configuration for the one or more tasks based on the score. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
compute a score indicative of a readiness of the UE, to participate in one or more tasks associated with learning model training, based at least in part on UE information; and
transmit an indication of the score.

2. The UE of claim 1, wherein the at least one processor is further configured to cause the UE to:
receive a configuration, wherein the configuration includes at least one of a quantization scheme, a quantity of bits, a periodicity, one or more trigger events, or a set of parameters for which the score is to be computed,
wherein the indication of the score is transmitted based at least in part on the configuration.

3. The UE of claim 1, wherein the at least one processor is further configured to cause the UE to:
receive a configuration for the one or more tasks; and
perform the one or more tasks based at least in part on the score and the received configuration.

4. The UE of claim 1, wherein the at least one processor is further configured to cause the UE to:
participate in the learning model training based at least in part on a value of the score satisfying a threshold; or
refrain from participating in the learning model training based at least in part on the value of the score satisfying the threshold.

5. The UE of claim 1, wherein, to compute the score, the at least one processor is further configured to cause the UE to compute a respective score for each functionality of a set of functionalities associated with learning model life cycle management.

6. The UE of claim 5, wherein the indication comprises a bitmap, and wherein each functionality of the set of functionalities corresponds to a respective bit value that is indicative of the readiness of the UE to support the respective functionality.

7. The UE of claim 1, wherein the UE information comprises a set of parameters, and wherein, to compute the score, the at least one processor is further configured to cause the UE to compute a respective score for each parameter of the set of parameters.

8. The UE of claim 7, wherein the indication comprises a bitmap, and wherein each parameter of the set of parameters corresponds to a respective bit value that is indicative of the readiness of the UE according to the respective parameter.

9. The UE of claim 7, wherein, to compute the score, the at least one processor is further configured to cause the UE to compute an average score based at least in part on the respective score for each parameter of the set of parameters, wherein the indication represents the computed average score.

10. The UE of claim 1, wherein the at least one processor is further configured to cause the UE to:
transmit the indication of the score based at least in part on a trigger event,
wherein the trigger event includes one or more of a change in a value of the score, a determination that the score satisfies a threshold, or a request to perform the learning model training or report the score.

11. The UE of claim 1, wherein the one or more tasks comprise collecting data, performing measurements, logging data, or reporting data.

12. The UE of claim 1, wherein the UE information comprises a set of parameters including one or more of a battery status of the UE, a hardware configuration of the UE, a buffer status of the UE, or a status of a current task performed by the UE.

13. The UE of claim 1, wherein, to transmit the indication of the score, the at least one processor is configured to cause the UE to transmit the indication via UE capability information, radio resource control (RRC) signaling, or a medium access control (MAC) control element (MAC-CE).

14. A network equipment (NE) for wireless communication, comprising:
at least one memory; and
at least one processor coupled with the at least one memory and configured to cause the NE to:
receive, from a user equipment (UE), an indication of a score indicative of a readiness of the UE, to participate in one or more tasks associated with learning model training, based at least in part on UE information; and
transmit a configuration for the one or more tasks based at least in part on the score.

15. The NE of claim 14, wherein:
the indication comprises a bitmap,
the UE information comprises a set of parameters,
each parameter of the set of parameters corresponds to a respective bit value that is indicative of the readiness of the UE according to the respective parameter, and
the at least one processor is further configured to cause the NE to compute an average score for the UE based at least in part on the indication.

16. The NE of claim 15, wherein the at least one processor is further configured to cause the NE to transmit signaling instructing the UE to perform the one or more tasks based at least in part on the average score.

17. The NE of claim 14, wherein the at least one processor is further configured to cause the NE to transmit a configuration, wherein the configuration includes at least one of a quantization scheme, a quantity of bits, a periodicity, one or more trigger events, or a set of parameters for which the score is to be computed,
wherein the indication of the score is received in accordance with the configuration.

18. The NE of claim 14, wherein the at least one processor is further configured to cause the NE to transmit a task reconfiguration for the one or more tasks based at least in part on the score.

19. A processor for wireless communication, comprising:
at least one controller coupled with at least one memory and configured to cause the processor to:
compute a score indicative of a readiness of the processor, to participate in one or more tasks associated with learning model training, based at least in part on processor information; and
transmit an indication of the score.

20. A method performed by a user equipment (UE), the method comprising:
computing a score indicative of a readiness of the UE, to participate in one or more tasks associated with learning model training, based at least in part on UE information; and
transmitting an indication of the score.
